(19) United States
(12) Patent Application Publication
(10) Pub. No.: US 2015/0088404 A1
(43) Pub. Date: Mar. 26, 2015

(54) MOTOR VEHICLE COMPRISING A DRIVE DEVICE THAT AUTOMATICALLY TURNS OFF WHEN A PERSON GETS OUT OF THE MOTOR VEHICLE, AND CORRESPONDING METHOD FOR THE MOTOR VEHICLE

(71) Applicant: AUDI AG, Ingolstadt (DE)

(72) Inventor: Martin Geissenhoener, Ingolstadt (DE)

(73) Assignee: AUDI AG, Ingolstadt (DE)

(21) Appl. No.: 14/394,974

(22) PCT Filed: Apr. 18, 2013
(86) PCT No.: PCT/EP2013/001154

§ 371 Date: Oct. 16, 2014

(30) Foreign Application Priority Data
Apr. 19, 2012 (DE) 10 2012 007 836.6

(51) Int. Cl. B60K 28/04; B60W 30/18; F02N 11/08; B60K 28/12

(52) U.S. Cl. CPC B60K 28/04; B60K 28/12; B60W 30/18054; B60W 30/18018; F02N 11/0803; F02N 11/0818; F02N 11/0822; B60K 2028/006
USPC 701/112

(57) ABSTRACT

A motor vehicle has a drive device, a control device for shutting down the drive device, a detection device for monitoring a presence of a person in the motor vehicle and a switching device for shutting down at least one predetermined electrical load. The control device is designed to shut down the drive device if the detection device signals that the person is leaving or has left the motor vehicle. The switching device is designed so that, following the shutdown of the drive device, it initially continues to operate the at least one predetermined load if said load was in operation at the time of the shutdown, and shuts it down only if a predetermined additional shutdown criterion is met.

### CROSS REFERENCE TO RELATED APPLICATIONS

This application is based on and hereby claims priority to International Application No. PCT/EP2013/001154 filed on Apr. 18, 2013 and German Application No. 10 2012 007 836.6 filed on Apr. 19, 2012, the contents of which are hereby incorporated by reference.

### BACKGROUND

The invention relates to a method for the shutdown of a drive device of a motor vehicle by a control device in the event that a driver of the motor vehicle leaves the latter while the drive device is switched on. The invention also includes a motor vehicle having a drive device, a control device for shutting down the drive device, a detection device for monitoring a presence of a person in the motor vehicle. A drive device means particularly an internal combustion engine, an electric motor or else a hybrid drive.

When a driver leaves his motor vehicle, this usually does not result in this automatically changing an operating state of the vehicle. The vehicle remains in the state in which the driver left it. If an internal combustion engine continues to run, the vehicle produces harmful exhaust gases. To reduce fuel consumption in short stopping phases, such as when stopping at a red traffic light, a motor vehicle may be provided with a start/stop system for such cases that stops an internal combustion engine when a stopping phase is detected. Since the driver usually does not leave the motor vehicle in this case, electrical loads of the motor vehicle continue to be operated, that is to say a radio or an air-conditioning installation, for example. In comparable fashion, an internal combustion engine of a hybrid drive is also switched off whenever it is not needed, that is to say including at the beginning of a stopping phase.

When a driver now stops the motor vehicle and then alights from it, the internal combustion engine is shut down by a start/stop system in this case too. For the driver, it then appears as though the motor vehicle is already completely shut down and he is able to remove himself from the motor vehicle for an indefinite time. Particularly if electrical loads with a relatively high power requirement continue to be operated (e.g. an air-conditioning installation) in this case, however, there is then the risk that the vehicle will not be able to be started again. If the motor vehicle is an electrically driven vehicle, this case arises particularly quickly.

In motor vehicles today, the risk of a driver forgetting to shut down his motor vehicle completely is particularly high for two further reasons. Firstly, in many cases a motor vehicle is no longer started with an ignition key that needs to be inserted into an ignition lock and turned. Instead, it is now often only necessary to push a button as a starting device for starting the motor vehicle. When getting out of a motor vehicle, the driver can therefore forget to push the button again in order to completely shut down the motor vehicle again. Secondly, drive devices today emit particularly little noise. Particularly electric motors produce no noise or only barely audible noise at a standstill. When a driver leaves the motor vehicle, he is thus not reminded by noises from the motor vehicle to shut down the drive device. As already explained, this danger may also exist in the case of a motor vehicle with an internal combustion engine if the latter has a start/stop system or a hybrid drive.

In order to improve user convenience for a driver in this respect, a motor vehicle may be provided with a detection device that monitors whether the driver leaves the motor vehicle. In such a case, as soon as the driver leaves the motor vehicle following a trip, both the drive motor and the electrical loads of the motor vehicle are shut down. This increases the economy of operation of the motor vehicle and at the same time reduces the risk of breakdown on account of a discharged battery. The signal from the detection device distinguishes between the presence and the absence of the driver. The detection device therefore has the advantage over a start/stop system that there is express detection of whether the driver is leaving or has left the motor vehicle.

Such a detection device is not only advantageous, however. For example, if a driver alights from his motor vehicle while other passengers are still in the motor vehicle, the automatic shutdown of the motor vehicle also shuts down the telephone installation, for example. If a person in the motor vehicle is currently on a telephone call, the telephone connection is therefore interrupted.

### SUMMARY

One possible object is to operate a motor vehicle economically and in a failsafe manner without this resulting in losses of convenience for the occupants.

The inventor proposes a method in which a detection device monitors whether the driver is leaving or has left the motor vehicle while the drive device is switched on, and then shuts down the drive device if need be. This is prompted by a control device, which may be part of an engine controller, for example. Following the shutdown of the drive device at least one electrical load continues to be operated if it was still in operation at the time of the shutdown. Such a load is shut down only if the load receives an additional shutdown signal.

The proposed method has the advantage that the interests of further passengers remaining in the motor vehicle can now be specifically taken into consideration. When the driver alights from the motor vehicle, only the drive device is shut down when he alights or immediately thereafter. Passengers can continue to use added-convenience loads, that is to say loads that provide a functionality in the motor vehicle that can be used by the passengers.

The proposed motor vehicle allows the implementation of the method. In this regard, the motor vehicle has not only the drive device itself and the aforementioned control device for shutting down the drive device but also a detection device for monitoring a presence of a person in the motor vehicle. The detection device may comprise a weight sensor, for example, that is fitted in the driver's seat. The control device shuts down the drive device if the detection device signals that the driver is leaving or has left the motor vehicle. An electrical switching device of the motor vehicle can specifically shut down at least one predetermined electrical load. However, the switching device is designed so that, following the shutdown of the drive device, it initially continues to operate the at least one predetermined load if said load was in operation at the time of the shutdown, and shuts it down only later if a predetermined additional shutdown criterion is met.

The shutdown criterion may particularly be that a signal is produced by a controller that also controls a locking installation for locking a vehicle door. In other words, the shutdown criterion is met when the driver activates the locking device of the motor vehicle. In the event of a locking request from the driver, it is certain that the added-convenience loads in the motor vehicle are also no longer needed and can therefore be shut down.

According to another embodiment of the method, the run-on time for added-convenience systems following the shut down of the drive device can be limited by virtue of the shutdown of the drive device prompting a timer to be started and a shutdown signal for the loads that are still in operation to be produced when the timer expires. This advantageously ensures that the power consumption by the added-convenience loads does not exceed a predetermined level.

In order to obtain even more precise control over the amount of energy consumed following the shutdown of the drive device, one embodiment of the method provides for the shutdown of the drive device to prompt a measuring device to be started that measures an amount of the energy consumed by the at least one load continuing to be operated, and to produce the shutdown signal when a predetermined maximum value for the measured energy is reached. An even more precise overview is obtained if, instead of the energy consumed by the loads, an electric power drawn from an energy store of the motor vehicle, for example the electric storage battery thereof, is measured directly.

It is particularly optimal in reference to energy consumption if the detection device additionally monitors whether, following the shutdown of the drive device, further persons have actually remained in the motor vehicle, and otherwise, if it is thus detected that the motor vehicle is empty, immediately produces the shutdown signal.

A particular increase in convenience that is perceived by passengers is when, following the shutdown of the drive device, at least one of the following added-convenience loads continues to be operated: an infotainment system, a telephone installation, a WLAN communication device (WLAN—wireless local area network), an air-conditioning installation, a seat heater, a seat ventilator, a seat massager, a fan of a passenger compartment ventilator.

In this case, in order to prevent the energy store of the motor vehicle from being unnecessarily loaded following the shutdown of the drive device, despite the increased convenience, provision may also be made for the switching-on of at least one predetermined electrical load to be blocked after the drive device has been shut down. In other words, only added-convenience loads that are already in operation in the event of shutdown continue to be operated, whereas others cannot be added thereafter.

In connection with a telephone installation and a WLAN communication device, an expedient development of the method provides for a communication device, that is to say a GSM radio module (GSM—global system for mobile communications) or a UMTS radio module (UMTS—universal mobile telecommunication system), for example, to check whether there is a telephone connection or a data connection to a communication network during shutdown of the drive device. If no such connection is detected, the communication device can send a shutdown signal to the telephone installation and/or the WLAN communication device, or generally to a data processing installation. This development of the method firstly ensures that no existing communication connections are interrupted. At the same time, it prevents a new connection from being set up following the shutdown of the drive device, which would mean waiting again until this connection is also terminated again by the user.

Instead of a check on the active telephone or data connections, provision may also be made for checking only whether there is actually at least one radio network coupling available, i.e. what is known as bonding, where although the mobile radio module is registered on the communication network, an active telephone or data connection is not set up. In that case, passengers in the motor vehicle can continue to be called.

In connection with the issue of how it is possible to detect whether the driver is leaving or has left the motor vehicle, many different technical approaches for implementing the detection device can be used. The provision of appropriate sensors makes it possible, by way of example, to check whether a person in the driver's seat has fastened his seatbelt or has opened the driver's door, or whether the weight of the person is encumbering an appropriate switch or sensor in the driver's seat. It is also possible to use the signals from sensors that are also used in a different context, such as those of an alarm installation. By way of example, alarm installations are capable of also detecting the presence of a person in the surroundings of the motor vehicle.

One advantageous development of the proposed method even provides for the detection device also to monitor whether a person is present in a predetermined monitoring area again, that is to say whether the driver or another person has returned to the motor vehicle again. For this purpose, it is also possible to use other sensors that cannot be used to detect when the motor vehicle is left, such as sensors that detect the operation of the steering wheel or of a pedal of the motor vehicle. In this case, the development of the method additionally provides for the drive device to be restarted by the control device if the detection device signals that a person is present again. This results in the advantage that the driver can alight for a short time, for example in order to open a garage door or to buy cigarettes, and can then return to the motor vehicle and continue driving without needing to manually restart the automatically shut-down drive device. Since the electrical loads continue to be operated following shutdown in this case, however, passengers can remain in the passenger compartment and use the loads.

The proposed motor vehicle may have features that have already been described here in connection with the developments of the method. For this reason, the corresponding developments of the proposed motor vehicle are not explained again here.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a schematic illustration of a potential embodiment of the proposed motor vehicle according to the invention; and

FIG. 2 shows a flowchart relating to a potential embodiment of the proposed method.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

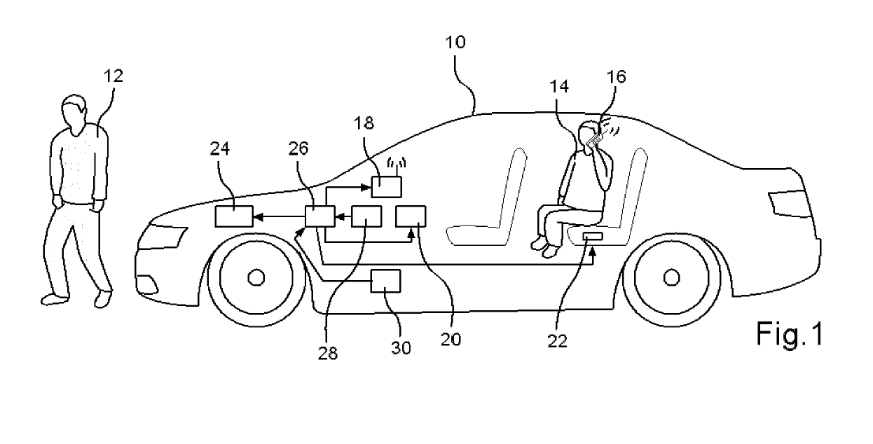

FIG. 1 shows a motor vehicle 10 from which a driver 12 has just got out. By way of example, the motor vehicle 10 may be a car. A further passenger 14, who is currently on a telephone call and to this end is using a telephone 16 that is connected by radio to a telephone installation 18 of the motor vehicle 10, has remained in the motor vehicle 10. The telephone 16 has used a telephone installation 18 to set up a communication connection to a communication network (not shown further) of a mobile radio provider. Furthermore, an air-conditioning installation 20 and a seat heater 22 are also running in the motor vehicle 10.

A drive motor 24 of the motor vehicle 10 has been shut down by a control device 26 of the motor vehicle 10 as the driver 12 left the motor vehicle 10. The drive device 24 may be an internal combustion engine, an electric motor or else a hybrid drive. The control device 26 may be a controller, for example.

The absence of the driver 12 has been detected by a detection device 28 that has then sent a corresponding signal to the control device 26. The detection device 28 may comprise a multiplicity of components that are suited to detecting the absence or the alighting of the driver 12 from the motor vehicle 10. In this case, it is also possible to resort to devices as are already known per se from the related art in another context for checking the presence of a person.

Although the control device 26 has switched off the drive motor 24, the telephone installation 18, the air-conditioning installation 20 and the seat heater 22 continue to be operated even after the shutdown of the drive motor 24. Hence, the telephone connection from the telephone 16 to the mobile radio network is maintained and the passenger 14 also continues to sit in an air-conditioned passenger compartment and on a heated seat. Only when the passenger 14 also alights from the motor vehicle 10 and the driver 12 locks the vehicle doors using an appropriate key or using a remote control, for example, are the telephone installation 18, the air-conditioning installation 20 and the seat heater 22 also shut down by the control device 26.

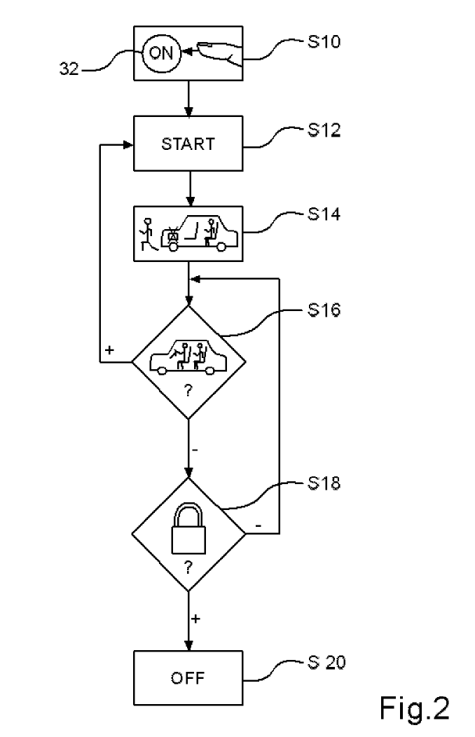

The method according to which the drive motor 24 and the added-convenience loads, i.e. the telephone installation 18, the air-conditioning installation 20 and the seat heater 22, are switched in the motor vehicle 10 is explained again below with reference to FIG. 1 and FIG. 2.

After the driver 12 got into the motor vehicle 10, he started the drive motor 24 by operating a starting device. By way of example, he pushed a starting button 30 in S10, which prompted the control device 26 to start the drive device 24 in S12 and also to allow a user to activate the added-convenience loads 18, 20, 22.

After the driver 12, as shown in FIG. 1, has now left the motor vehicle 10, this is detected by the detection device 28 and, in S14, the control device 26 initially shuts down only the drive motor 24, but not the added-convenience loads 18, 20, 22. In S16, the detection device 28 monitors whether the driver 12 has returned to the motor vehicle again. If this is the case (+), the drive device 24 is automatically restarted by the control device 26 (S12) after the control device 26 has received the signal about the return of the driver 12 from the detection device 28.

Otherwise, if the detection device 28 continues to signal the absence of the driver 12, a check is performed in S18 to determine, by way of example, whether a locking installation 30 has received a locking request, for example from a remote control of the driver 12, by virtue of the driver 12 having pushed an appropriate button on the remote control. If this is not the case, the check for the return of the driver 12 is repeated (return to S16). If the locking device 30 is intended to lock the motor vehicle 10, on the other hand, this is signaled by the locking device 30 to the control device 26 too, which then sends a shutdown signal to the added-convenience loads 18, 20, 22 that are still in operation, these then likewise being shut down in S20 (OFF). In this case, the control device 26 is thus simultaneously a switching device for shutting down the added-convenience loads 18, 20, 22.

The concept described can be used for all types of drive (internal combustion engine, hybrid vehicle and electric vehicle). The shutdown of the drive motor after the driver 12 has alighted reduces an energy consumption for the motor vehicle and hence the risk of breakdown. Furthermore, the vehicle is put into a safe state, so that, by way of example, children who have remained in the motor vehicle 10 cannot set the motor vehicle 10 in motion themselves. Since particular added-convenience systems continue to remain active for a run-on time after the ignition has been shut down, the passengers who have remained in the vehicle continue to be provided with a high level of convenience, and active telephone coupling is also not lost. A locking request from the driver can be used to terminate the added-convenience run-on in a specific manner, since there is now a high likelihood that no-one else is using the added-convenience systems in the motor vehicle 10.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-12. (canceled)

13. A method for shutting down a drive device, formed from an internal combustion engine and/or an electric motor, of a motor vehicle by a control device when a driver of the motor vehicle leaves the motor vehicle while the drive device is switched on, the method comprising:
monitoring, using a detection device, whether the driver is leaving or has left the motor vehicle;
shutting down, by the control device, the drive device if the detection device signals that the driver is leaving or has left the motor vehicle;
checking, by a communication device, whether there is a telephone connection of a communication installation to a communication network of a mobile radio provider, to thereby determine if the telephone installation is in operation, the communication device checking while the drive device is being shut down;
sending, by the communication device, a shutdown signal to the telephone installation if no connection is detected; and
allowing the telephone installation to continue operation after the drive device is shut down if the telephone installation was in operation when the drive device was shut down, and thereafter shutting down the telephone installation only if the telephone installation receives an additional shutdown signal.

14. The method according to claim 13, wherein
in addition to the telephone installation, an added-convenience load is allowed to continue operation after the drive device is shut down if the added-convenience load was in operation when the drive device was shut down, and
the added-convenience load is a device that provides a functionality in the motor vehicle that can also be used by passengers.

15. The method according to claim 13, wherein the additional shutdown signal is produced by a controller that also controls a locking installation for locking a vehicle door.

16. The method according to claim 13, wherein
shutting down of the drive device prompts a timer to be started, and
the additional shutdown signal is produced when the timer expires.

17. The method according to claim 13, wherein
shutting down of the drive device prompts a measuring device to be started that measures an amount of electric power consumed by the telephone installation continuing to be operated or an amount of electric power drawn from an energy store of the motor vehicle by the telephone installation continuing to be operated, and
the measuring device produces the additional shutdown signal when the amount of electrical power consumed or drawn reaches a predetermined maximum value.

18. The method according to claim 13, wherein
in addition to the telephone installation, a predetermined electrical load is allowed to continue operation after the drive device is shut down if the predetermined electrical load was in operation when the drive device was shut down,
shutting down of the drive device prompts a measuring device to be started that measures an amount of electric power consumed by the telephone installation and the predetermined electrical load continuing to be operated or an amount of electric power drawn from an energy store of the motor vehicle, and
the measuring device produces the additional shutdown signal when the amount of electrical power consumed or drawn reaches a predetermined maximum value.

19. The method according to claim 13, wherein
the detection device monitors whether another person remained in the motor vehicle following shutdown of the drive device, and
the additional shutdown signal is produced if the detection device determines that no other person remains in the motor vehicle.

20. The method according to claim 13, wherein
the detection device monitors whether another person remained in the motor vehicle following shutdown of the drive device, and
the telephone installation is allowed to continue operation after the drive device is shut down if the telephone installation was in operation when the drive device was shut down and if another person remained in the motor vehicle following shutdown.

21. The method according to claim 13, wherein
the control device shuts down the drive device if the detection device signals that the driver is leaving or has left a predetermined monitoring area of the motor vehicle,
the detection device monitors whether the predetermined monitoring area is again occupied by a person, and
the drive device is restarted by the control device when the detection device signals that the predetermined monitoring area is again occupied.

22. The method according to claim 13, wherein following shutdown of the drive device, switching-on of at least one predetermined electrical load is blocked.

23. The method according to claim 14, wherein
after shutting down the drive device, both the telephone installation and the added-convenience load are shut down only if the additional shutdown signal is received, and
the additional shutdown signal is produced by a controller that also controls a locking installation for locking a vehicle door.

24. The method according to claim 23, wherein
shutting down of the drive device prompts a timer to be started, and
the additional shutdown signal is produced when the timer expires.

25. The method according to claim 24, wherein
shutting down of the drive device prompts a measuring device to be started that measures an amount of electric power drawn from an energy store of the motor vehicle, by the telephone installation and the added-convenience load continuing to be operated, and
the measuring device produces the additional shutdown signal when the amount of electrical power drawn reaches a predetermined maximum value.

26. The method according to claim 25, wherein
the detection device monitors whether another person remained in the motor vehicle following shutdown of the drive device, and
the telephone installation and the added-convenience load are allowed to continue operation after the drive device is shut down if the telephone installation and the added-convenience load were in operation when the drive device was shut down and if another person remained in the motor vehicle following shutdown.

27. The method according to claim 26, wherein
the control device shuts down the drive device if the detection device signals that the driver is leaving or has left a predetermined monitoring area of the motor vehicle,
the detection device monitors whether the predetermined monitoring area is again occupied by a person, and
the drive device is restarted by the control device when the detection device signals that the predetermined monitoring area is again occupied.

28. The method according to claim 27, wherein following shutdown of the drive device, switching-on of at least one predetermined electrical load is blocked.

29. A motor vehicle comprising:
a drive device formed from an internal combustion engine and/or an electric motor;
a detection device to monitor for presence of a person in the motor vehicle;
a control device to shut down the drive device if the detection device signals that the person is leaving or has left the motor vehicle; and
a switching device to:
shut down a telephone installation and/or a WLAN communication device;
allow the telephone installation and/or the WLAN communication device to continue operation after shutdown of the drive device if there is a telephone connection or a data connection to a communication network when the drive device is shut down, thereby indicating that the telephone installation and/or the WLAN communication device was in operation when the drive device is shut down; and
thereafter shutting down the telephone installation and/or the WLAN communication device only if a predetermined additional shutdown criterion is met.

30. The motor vehicle according to claim 29, wherein
the predetermined additional shutdown criterion is locking of the motor vehicle, and
the switching device is designed to shut down the telephone installation and/or the WLAN communication device when a locking device of the motor vehicle is activated.

31. The motor vehicle according to claim 29, wherein
in addition to the telephone installation and/or the WLAN communication device, the switching device allows at least one added-convenience load to continue to operate after shutdown of the drive device,
the at least one added-convenience load is thereafter shut down only if the additional shutdown criterion is met, and
the at least one added-convenience load is selected from the group consisting of an infotainment system, an air-conditioning installation, a seat heater, a seat ventilator, a seat massager, and a fan of a passenger compartment ventilator.
